(19) United States
(12) Patent Application Publication
(10) Pub. No.: US 2015/0163865 A1
(43) Pub. Date: Jun. 11, 2015

(54) APPARATUS FOR CONTROLLING A RECIPE IN A COOKING APPARATUS BASED ON USER AUTHENTICATION

(71) Applicant: Dongbu Daewoo Electronics Corporation, Seoul (KR)

(72) Inventor: Joung Won LEE, Seoul (KR)

(73) Assignee: Dongbu Daewoo Electronics Corporation, Seoul (KR)

(21) Appl. No.: 14/167,966

(22) Filed: Jan. 29, 2014

(30) Foreign Application Priority Data
Dec. 10, 2013 (KR) 10-2013-0152945

(51) Int. Cl. H05B 6/68; A23L 1/01; H05B 6/66; G05B 15/02

(52) U.S. Cl. CPC H05B 6/687; G05B 15/02; A23L 1/01; H05B 6/668

(57) ABSTRACT

A method for controlling a recipe based on user authentication includes authenticating, validating or recognizing user ID information by searching an ID information database, fetching, retrieving or reading recipe and/or setting information for respective recipes and/or menus associated with or corresponding to the authenticated, validated or recognized user ID information from a user-based recipe information database when the user ID information is valid, and executing a selected recipe and/or menu based on corresponding recipe and/or setting information when one of the respective recipes and/or menus is selected.

### CROSS-REFERENCE TO RELATED APPLICATIONS

This application is based on and claims priority from Korean Patent Application No. 10-2013-0152945, filed on Dec. 10, 2013, the disclosure of which is incorporated herein in its entirety by reference.

### TECHNICAL FIELD

The present invention relates to a scheme for controlling a recipe in a cooking apparatus, and more particularly, to a method and apparatus for controlling a recipe in an electronic cooking apparatus based on user authentication that are suitable for executing user-selective recipes based on recipe and/or setting information for respective recipes and/or menus that are classified and previously set and/or stored according to one or more users.

### BACKGROUND

As well known, a microwave oven is a kind of cooking apparatus, in which an ultrahigh frequency of several thousands of MHz is generated by applying high voltage to a high frequency oscillation tube, such as a magnetron. The generated ultrahigh frequency is absorbed by food and/or water molecules within the food that generate vibrations, so that a frictional force is generated within the food, and the food is cooked by the frictional force.

Such a microwave oven has many uses, including various settings and/or recipes (e.g., boiling, steaming, and roasting) in addition to a simple function for warming, thawing, and/or cooking food, based on electronic control and/or according to recent electronic technology. Furthermore, the microwave oven is generally considered to be an essential household cooking apparatus.

Furthermore, a common microwave oven provides a function in which a user can register (or store) recipe setting information for desired recipe menus with (or in) the microwave oven, fetch or retrieve the stored recipe setting information, and execute a desired recipe menu based on the recipe setting information.

However, if many users use the same conventional microwave oven and the users register and use different recipe settings (information) for desired menus, the conventional microwave oven may be problematic in that each user may need to perform a complicated sequence of steps using a user interface to search for recipe setting information for his or her menus to perform the desired recipe based on the retrieved recipe setting information.

For example, assuming that the number of users who use a microwave oven is 10 and each user has previously registered 5 to 10 recipe settings. Each user may need to fetch and/or read 50 to 100 recipe settings from memory and then check the 50 to 100 recipe settings one by one by the naked eye to search for the desired recipe setting information for a desired menu.

### SUMMARY

In view of the above, the present invention provides a new scheme (e.g., a language-based coupon service scheme), in which user identification (ID) information for executing a recipe recognizes previously registered valid information (e.g., valid recipe setting information or parts, portions or pieces thereof) for respective recipe menus previously registered in relation to the recognized user ID information are retrieved or read from a user-based recipe information database (DB) and displayed, and when one of the recipes (or parts, portions or pieces thereof) is selected, the selected recipe is executed based on previously set recipe setting information for the selected recipe menu.

Technical objects to be achieved by the present invention are not limited to the aforementioned object(s), and other technical objects that have not been described above will become evident to those skilled in the art to which the present invention pertains from the following description.

Exemplary embodiments of the present disclosure provide a method for controlling a recipe in a cooking apparatus based on user authentication, including authenticating or validating user identification (ID) information by searching an ID information database (DB) and recognizing the user ID information; fetching, retrieving, and/or reading recipe and/or setting information (or one or more pieces, portions or bits thereof) for respective recipes and/or menus previously registered in relation to user ID information from a user-based recipe information DB (e.g., when the user ID information is found or determined to be valid); and executing a selected recipe and/or menu based on corresponding or selected recipe and/or setting information (e.g., when a previously registered recipe and/or menu is selected).

The method for controlling a recipe based on user authentication may further include matching recipe and/or setting information for a specific recipe and/or menu with the user ID information (e.g., when the specific menu is requested to be registered) by providing the recipe and/or setting information for the specific recipe and/or menu and storing the matched recipe and/or setting information and specific recipe and/or menu in the user-based recipe information DB, before authenticating or validating the user ID information.

The user ID information may include fingerprint recognition information (e.g., a fingerprint), iris recognition information (e.g., an iris scan), and/or face recognition information (e.g., a map or partial map of predetermined facial structures or features, such as the eyes, eye brows, nose, mouth, etc.).

The recipe and/or setting information (e.g., for the previously registered recipe and/or menu) may include at least one of a heating time, a heating temperature, and a heating method.

The recipe and/or setting information may further include a recipe start and/or schedule time.

The method for controlling a recipe based on user authentication may further include providing an interface that allows selecting from a plurality of previously set basic recipes and/or menus when the user ID information is not to be valid, and executing the selected basic recipe and/or menu.

The method for controlling a recipe based on user authentication may further include stopping, shutting down, or turning off the cooking apparatus when the user ID information is not to be valid.

Stopping, shutting down, or turning off the cooking apparatus may further include generating a visual and/or auditory alarm.

Exemplary embodiments of the present disclosure also provide an apparatus for controlling a recipe based on user authentication, including an ID information database (DB) configured to store user identification (ID) information (e.g., previously registered by one or more users), a user-based recipe information database (DB) configured to store recipe and/or setting information for respective recipes and/or menus that match the user ID information, an ID information acquisition unit configured to acquire and/or receive user ID information (e.g., from a user who tries to use the cooking apparatus), a user authentication unit configured to authenticate, validate or recognize the user ID information and search the ID information database (DB) when the user ID information is received or acquired, a recipe and/or menu display unit configured to fetch, retrieve or read recipe and/or setting information for respective recipes and/or menus associated with or corresponding to the user ID information from the recipe information DB (e.g., when the user ID information is authenticated, validated, recognized or valid), and display the recipe and/or setting information in a display panel of the cooking apparatus, and a recipe execution unit configured to execute a recipe menu selected from corresponding recipe and/or setting information in the display panel.

The ID information acquisition unit may include one or more of a fingerprint recognizer, an iris recognizer, and a face recognizer.

The recipe menu display unit may display a limited menu selection screen including previously set basic recipes and/or menus in the display panel when the user ID information is not authorized (e.g., impossible authentication is received from the user authentication unit), and/or the recipe execution unit may execute the selected basic recipe and/or menu (e.g., based on the basic recipe and/or setting information) from one of the previously set basic recipes and/or menus.

Further exemplary embodiments of the present disclosure provide a method for controlling a recipe based on user authentication, including requesting an external device to authenticate user ID information by sending the user ID information to the external device (e.g., for recognizing the user ID information for executing cooking, retrieving or reading recipe and/or setting information for respective recipes and/or menus that may be registered or stored in a recipe and/or menu DB and associated with or corresponding to the user ID information from a user-based recipe information DB when the external device authenticates, validates or recognizes the user ID information), and executing a selected recipe and/or menu based on corresponding recipe and/or setting information when a recipe and/or menu (e.g., one of the previously registered recipes and/or menus) is selected.

The method for controlling a recipe based on user authentication may further include providing an interface that enables selection of previously set basic recipes and/or menus for the cooking apparatus when the external device does not authenticate the user ID information, and executing a selected basic recipe and/or menu (e.g., when one of the previously set basic recipes and/or menus is selected).

Exemplary embodiments of the present disclosure provide an apparatus for controlling a recipe based on user authentication, including a user-based recipe information database DB configured to store recipe and/or setting information for respective recipes and/or menus that match the user ID information, an ID information acquisition unit configured to acquire or receive ID information from a user using the apparatus, a remote authentication unit configured to request an external device to authenticate, validate or recognize the user ID information and send the user ID information to the external device when the user ID information is acquired or received, a recipe and/or menu display unit fetch, retrieve or read recipe and/or setting information for respective recipes and/or menus previously registered and/or stored in relation to the authenticated, validated or recognized user ID information from the user-based recipe information DB when the external device authenticates, validates or recognizes the user ID information, and display the recipe and/or setting information in a display panel of the apparatus, and a recipe execution unit configured to execute a selected recipe and/or menu based on corresponding recipe and/or setting information (e.g., when the selected recipe and/or menu displayed in the display panel is selected).

The recipe and/or menu display unit may display a limited menu selection screen including previously set basic recipes and/or menus for the apparatus in the display panel when the external device does not authenticate, validate or recognize the user ID information, and the recipe execution unit may execute a selected basic recipe and/or menu based on the previously set basic recipe and/or setting information (e.g., when one of the previously set basic recipes and/or menus is selected).

### BRIEF DESCRIPTION OF THE DRAWINGS

The objects and features of the present invention will become apparent from the following description of embodiments given in conjunction with the accompanying drawings, in which:

FIG. 1 is a block diagram of an apparatus for controlling a recipe based on user authentication in accordance with exemplary embodiments of the present invention;

FIG. 2 is a flowchart illustrating major processes of providing user-selective recipe control service based on user authentication in accordance with the exemplary embodiments of the present invention;

FIG. 3 is a block diagram of an apparatus for controlling a recipe based on user authentication in accordance with other exemplary embodiments of the present invention; and

FIG. 4 is a flowchart illustrating major processes of providing user-selective recipe control service based on user authentication in accordance with other exemplary embodiments of the present invention.

### DETAILED DESCRIPTION

First, the merits and characteristics of the present invention and the methods for achieving the merits and characteristics thereof will become more apparent from the following embodiments taken in conjunction with the accompanying drawings. However, the present invention is not limited to the disclosed embodiments, but may be implemented in various ways. The embodiments are provided to complete the disclosure of the present invention and to enable a person having ordinary skill in the art to understand the scope of the present invention. The present invention is defined by the claims.

In describing the embodiments of the present invention, a detailed description of known functions or constructions related to the present invention may be omitted if it is deemed that such description would make the gist of the present invention unnecessarily vague. Furthermore, terms to be described later are defined by taking the functions of embodiments of the present invention into consideration, and may be different according to the operator's intention or usage. Accordingly, the terms should be defined based on the overall contents of the specification.

Hereinafter, embodiments of the present invention will be described in detail with reference to the accompanying drawings which form a part hereof.

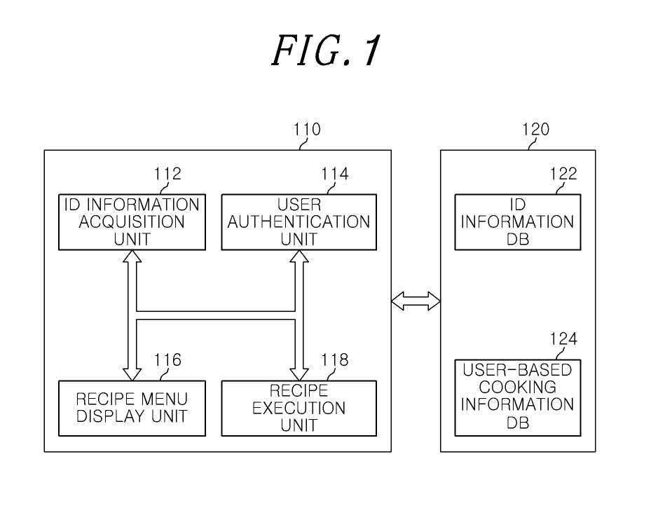

FIG. 1 is a block diagram of an apparatus for controlling a recipe based on user authentication in accordance with exemplary embodiments of the present invention. Referring to FIG. 1, the recipe control apparatus may basically include a recipe control module 110 and a database (DB) module 120.

The recipe control module 110 may include an ID information acquisition unit 112, a user authentication unit 114, a recipe and/or menu display unit 116, and a recipe execution unit 118. The DB module 120 may include an ID information DB 122 and a user-based recipe information DB 124.

First, the ID information acquisition unit 112 can provide one or more functions, including acquiring, receiving and/or recognizing information (e.g., fingerprint recognition information, iris recognition information, or face recognition information) about the ID of a user (hereinafter referred to as “user ID information”) who will use the cooking apparatus, and transferring the user ID information to the user authentication unit 114. The ID information acquisition unit 112 may include any one of, for example, a fingerprint recognizer, an iris recognizer, and a face recognizer. The fingerprint recognizer may include a fingerprint scanner, and each of the iris recognizer and the face recognizer may include an imager or camera (e.g., for photographing, imaging or scanning the iris, face or one or more facial features, such as the eyes, eye brows, nose, mouth, chin, etc.). If the fingerprint recognizer includes a fingerprint scanner, the fingerprint scanner may be on a surface or at a position where the user holds the door of the cooking apparatus to open the door. If each of the iris recognizer and the face recognizer includes an imager or camera, the imager or camera may be on an upper end or a lower end of a front part, panel or section of the cooking apparatus.

The user authentication unit 114 can provide one or more functions, including authenticating, validating or recognizing acquired or received user ID information by searching the ID information DB 122 of the DB module 120 (e.g., when the user ID information is received from the ID information acquisition unit 112, comparing the received user ID information to ID information stored in the ID information DB 122), and transferring a result of the authentication, validation or recognition (i.e., authentication, verification, validation or recognition; no authentication, verification, validation or recognition; or impossible authentication) to the recipe menu display unit 116.

ID information for users of the cooking apparatus may be registered and stored in the ID information DB 122. The ID information acquisition unit 112 may therefore ask the user whether the user's ID information has been registered (e.g., stored in the ID information acquisition unit 112), and if the user answers “no,” the ID information acquisition unit 112 may ask the user to register his or her user ID. For example, any one of fingerprint information, iris information, and face information may be used as such ID information.

The recipe menu display unit 116 can provide one or more functions, including fetching, retrieving and/or reading recipe and/or setting information related to one or more recipes and/or menus that have been previously registered or stored in relation to the authenticated, validated or recognized user ID information by searching the user-based recipe information DB 124 of the DB module 120 when the user ID information is authenticated, valid or recognized by the user authentication unit 114. Subsequently, the recipe menu display unit 116 can output or display the fetched, retrieved, or read the recipe and/or setting information (and possibly the corresponding recipe and/or menu) to or on the display panel (not shown) of the cooking apparatus.

Furthermore, the recipe menu display unit 116 can further fetch, retrieve or read a limited menu selection screen that provides or displays only basic recipes and/or menus (which may be previously set or stored) to invalid (e.g., non-authenticated or unrecognized) users from the user-based recipe information DB 124 when the authentication, verification, validation or recognition result indicates that the user ID information is invalid, unauthorized or not recognized, and output the limited menu selection screen to the display panel of the cooking apparatus. Here, the previously set basic recipe menus may refer to relatively simple menus, such as warming, cooking, fermenting, or thawing, optionally for a predetermined length of time, from a functional viewpoint.

Recipe and/or setting information (e.g., recipes, settings, or parts, pieces, or portions thereof) for previously registered or stored recipes or menus that match the registered, authorized or validated user ID information (e.g., a registered user of the cooking apparatus), and basic recipe and/or setting information for previously set or stored basic recipes and/or menus that may be displayed on the limited menu selection screen, are stored in the user-based recipe information DB 124.

Here, recipe and/or setting information for a recipe and/or menu desired by a user may be registered or stored by displaying on the display panel a preference menu setting screen including requests to input a plurality of items for recipe and/or setting information and/or for a specific recipe and/or menu in response to a request from the user to store or register the information, recipe and/or menu. The plurality of items for recipe and/or setting information and/or for a specific recipe and/or menu may include a name of the recipe or menu, a number of cooking stages, a power setting and/or a time setting for each stage, a delay between cooking stages, a rotation rate for a rotating plate in the cooking apparatus (optionally for each stage), whether the plate rotation direction changes in a successive cooking stage, etc. The specific recipe menu and the recipe setting information are matched with the user ID information when the user selects or inputs recipe and/or setting information (e.g., for each of the plurality of items) and requests the recipe and/or setting information to be registered (or manipulates a registration request).

The specific recipe and/or menu and the recipe and/or setting information are then stored in the user-based recipe information DB 124. The recipe setting information for each previously registered or stored recipe and/or menu may further include one or more of, for example, a heating time, a heating temperature, and a heating method of the recipe and/or menu, and may selectively include a previously set recipe schedule start time.

The recipe execution unit 118 can provide one or more functions, including executing a recipe (e.g., a selected recipe from a menu of recipes) based on the displayed recipe and/or setting information for the selected recipe and/or menu, when the recipe and/or setting information for one of previously registered or stored recipes and/or menus displayed on the display panel of the cooking apparatus (e.g., the recipe start interface of the registered recipe and/or menu) is selected.

Furthermore, the recipe execution unit 118 can execute a selected basic recipe and/or menu based on previously set or stored (and displayed) basic recipe and/or setting information for the selected basic recipe and/or menu when the recipe and/or setting information for one of the basic recipes and/or menus (e.g., using the recipe start interface of the basic recipe menu) is selected from the limited menu selection screen in which previously set or stored basic recipes and/or menus are displayed.

Here, the basic recipe and/or setting information may include, for example, a basic cooking temperature and a basic cooking time. The basic cooking temperature and the basic cooking time may be a cooking temperature (e.g., 40 degrees or less) and a cooking time (e.g., 30 seconds or less). The basic cooking temperature and the basic cooking time may be selected in consideration of user safety (e.g., assuming the non-registered user may be a child).

A series of processes for selectively providing recipe control for each user of a cooking apparatus based on user authentication using the recipe control apparatus in accordance with the present embodiments are described in detail below.

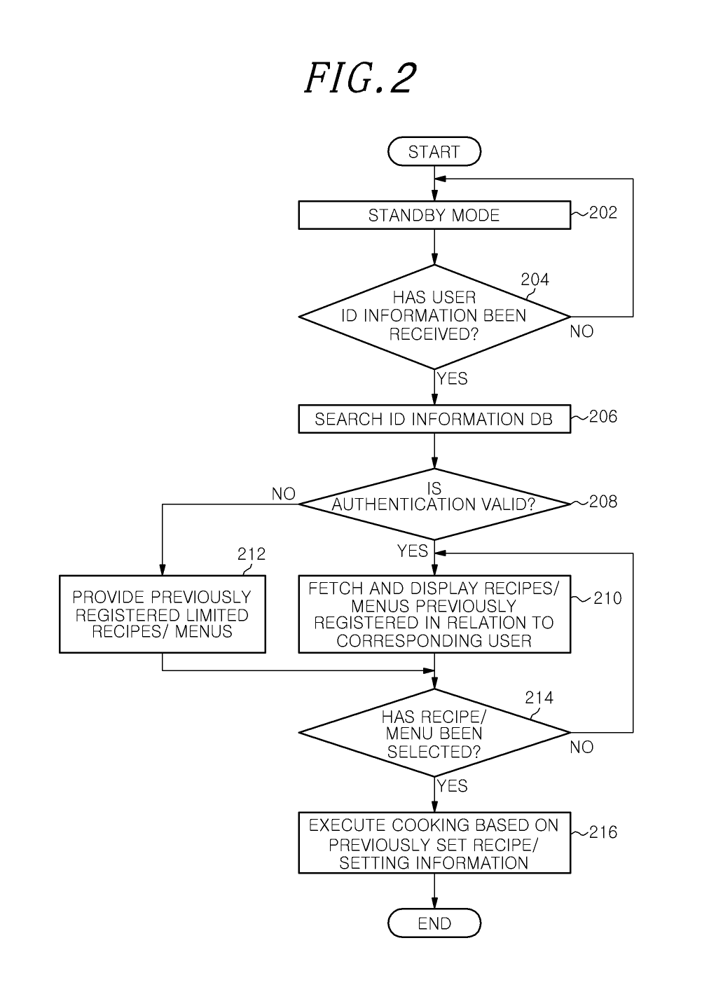

FIG. 2 is a flowchart illustrating major processes for providing user-selective recipe control based on user authentication in accordance with embodiments of the present invention.

For convenience of description and a better understanding, it is assumed that a plurality of user IDs have been previously registered with or stored in the ID information DB 122, and plural recipes and/or settings corresponding to previously registered recipes and/or menus have been matched to each of the registered user IDs information have been stored in the user-based recipe information DB 124.

Referring to FIG. 2, while the cooking apparatus is in a standby mode at step 202, the ID information acquisition unit 112 determines whether or not information for the ID of a user using the cooking apparatus has been input, acquired or recognized at step 204. If the user ID information is input, acquired or recognized, the ID information acquisition unit 112 transfers the user ID information to the user authentication unit 114. The user recognition information may comprise, for example, fingerprint recognition information, iris recognition information, and/or face recognition information.

The user authentication unit 114 attempts to authenticate, validate or recognize the recognized user ID information (e.g., determine validity) at step 208 by first searching the ID information DB 122 of the DB module 120 for the recognized user ID information at step 206. If the user ID information from the ID information acquisition unit 112 matches user ID information stored in the ID information DB 122, then the user authentication unit 114 authenticates, validates or recognizes the user ID information from the ID information acquisition unit 112. Otherwise, the user authentication unit 114 does not authenticate, validate or recognize the user ID information from the ID information acquisition unit 112, and the user ID information is considered to be invalid.

If, as a result of the authentication or recognition at step 208, the user ID information is valid (e.g., ID information previously registered or stored in the ID information DB 122), the user authentication unit 114 informs the recipe and/or menu display unit 116 of a corresponding valid and/or authenticated user (e.g., notifies or sends a validity confirmation signal to the display unit 116). If, as a result of the authentication and/or recognition attempt at step 208, the user ID information is found or determined not to be valid (i.e., ID information not previously registered with or stored in the ID information DB 122), the user authentication unit 114 informs the recipe and/or menu display unit 116 of corresponding failed (e.g., impossible) authentication.

When authentication indicating that the user ID information is valid is received from user authentication unit 114 through the authentication process, the recipe and/or menu display unit 116 searches the user-based recipe information DB 124 for recipes and/or menus previously registered by the user. Subsequently, recipe and/or setting information corresponding to the user's stored recipes and/or menus are read or retrieved, and the recipe and/or menu display unit 116 outputs or displays the retrieved recipes and/or menus (or retrieved recipe and/or setting information) to or on the display panel at step 210.

In response thereto, the user may designate or select one of the previously registered recipes or menus displayed on the screen of the display panel or interface and manipulate the recipe (e.g., from the selected recipe and/or menu) at step 214. When the user selects one of the recipes and/or menus, and optionally manipulates the selected recipe and/or menu, the recipe execution unit 118 executes the selected recipe and/or menu based on the recipe and/or setting information related to the selected recipe and/or menu at step 216.

If an authentication signal indicating that the user ID information is invalid is received from the user authentication unit 114, the recipe and/or menu display unit 116 fetches, retrieves, or reads previously set basic recipes and/or menus from the user-based recipe information DB 124, configures a limited menu selection screen using the retrieved, read or fetched basic recipes and/or menus, and provides or outputs the limited menu selection screen to the display panel at step 212.

The basic recipes and/or menus may refer to basic recipe and/or menu operations (e.g., warming, fermentation, thawing, and cooking) to be provided to invalid or unregistered users (i.e., users whose user ID information has not been registered). The cooking apparatus may provide a plurality of basic recipes and/or menus to unregistered users.

In response thereto, the user may designate or select one of the basic recipes and/or menus displayed on the display panel or interface, and select a recipe from the displayed recipes and/or menus at step 214. When the user selects one of the basic recipes or menus (and optionally manipulates or makes changes ti the selected recipe and/or menu), the recipe execution unit 118 executes the selected basic recipe and/or menu based on the basic recipe and/or setting information displayed at step 216.

In embodiments of the present disclosure, a user may select recipes for basic recipes and/or menus to be provided to all users, including invalid or unregistered users, from a plurality of recipes and/or menus provided by the cooking apparatus. Alternatively, the operation of the cooking apparatus may automatically stop or turn off when the user ID information is invalid (e.g., not authenticated). In such a case, the cooking apparatus may further provide a visual and/or auditory alarm when it is stopped or turned off.

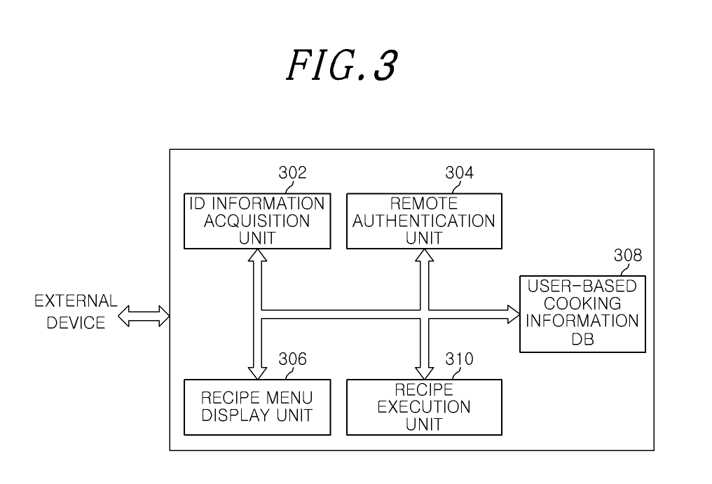

FIG. 3 is a block diagram of an apparatus for controlling a recipe based on user authentication in accordance with other exemplary embodiments of the present invention. The recipe control apparatus of various embodiments may include an ID information acquisition unit 302, a remote authentication unit 304, a recipe menu display unit 306, a user-based recipe information DB 308, and a recipe execution unit 310.

The exemplary recipe control apparatus of FIG. 3 is similar or substantially the same as that of FIG. 1, except that the recipe control apparatus of FIG. 3 includes information for the registered IDs of users, which are registered and/or managed using the ID information database DB, locally in the apparatus or remotely with an external device.

For example, a user using the cooking apparatus is authenticated using user ID information registered with an external device (not shown) to assign and/or manage user rights in the external device and apply use limits with the external device. The external device may be, for example, a home network controller.

First, an ID information acquisition unit 302 may have the same construction as the ID information acquisition unit 112 of FIG. 1. The ID information acquisition unit 302 can provide one or more functions, including receiving, acquiring and/or recognizing user ID information (e.g., fingerprint recognition information, iris recognition information, or face recognition information) from a user who tries to use the cooking apparatus, and transferring the user ID information to a remote authentication unit 304.

The remote authentication unit 304 can provide one or more functions, including requesting authentication of the user ID information from an external device (e.g., the home network controller) by sending the user ID information, together with an authentication request, signal or message, to the external device over a network. The user ID information is received from the ID information acquisition unit 302, and the remote authentication unit 304 transfers a result of the authentication attempt (e.g., an authentication response, signal and/or message or an non-authentication response, signal and/or message), received from the external device in response to the authentication request, to the recipe and/or menu display unit 306.

Furthermore, the network (e.g., the home network) between the remote authentication execution unit 304 of the recipe control apparatus and the external device (e.g., the home network controller) may be implemented using a communication network that is well known in the art, for example, mobile communication, a wireless LAN, a power line communication network, and/or Zigbee communication. Accordingly, the authentication request, signal and/or message including the user ID information and the authentication response, signal and/or message (or the non-authentication response, signal and/or message) may have a message format according to the corresponding communication method.

The recipe and/or menu display unit 306 can provide one or more functions, including searching the user-based recipe information DB 308 for recipe and/or setting information for recipes and/or menus that have been previously stored or registered for a certain registered user (e.g., in relation to or corresponding to the authenticated user ID information) when validation and/or authentication indicating that the user ID information is valid is received from the remote authentication unit 304, and outputting and/or displaying the retrieved recipes and/or menus to or in the display panel (not shown) of the cooking apparatus.

Furthermore, the recipe and/or menu display unit 306 can provide one or more functions, including configuring a limited menu selection screen in which only basic recipes and/or menus are provided to unregistered or invalid users (i.e., a screen displays only previously set or stored basic recipes and/or menus) when authentication indicates that the user ID information is invalid (i.e., not authenticated, validated or recognized; e.g., “impossible” authentication), and displaying the limited menu selection screen to the display panel of the cooking apparatus.

Here, recipe and/or setting information for a recipe and/or menu desired by a user may be registered in a manner substantially similar to that described above. For example, a preference menu setting screen including a plurality of items for inputting recipe and/or setting information for a specific recipe and/or menu in response to a request from the user is provided to the display panel, the specific recipe and/or menu and the recipe and/or setting information for the specific recipe and/or menu are matched or associated with the user ID information when the user selects or input recipe and/or setting information for each item and requests the recipe and/or setting information to be registered (or manipulates a registration request), and the specific recipe and/or menu and the recipe and/or setting information are stored in the user-based recipe information DB 308.

The recipe execution unit 310 can provide one or more functions, including executing a recipe for a selected recipe and/or menu based on previously set or stored recipe and/or setting information for the selected recipe and/or menu when the recipe for a previously registered or stored recipe and/or menu that displayed in the display panel of the cooking apparatus (i.e., the recipe start interface of the registered recipe menu) is selected.

Furthermore, the recipe execution unit 310 can provide execute a recipe for a selected basic recipe and/or menu based on previously set or stored basic recipe and/or setting information for the selected basic recipe and/or menu when the basic recipe and/or menu (e.g., selected using the recipe start interface of the basic recipe menu) is selected from the limited menu selection screen in which basic recipes and/or menus are displayed.

A series of processes for selectively providing recipe control to each user of a cooking apparatus based on user authentication using the recipe control apparatus in accordance with embodiments of the present disclosure are described in detail below.

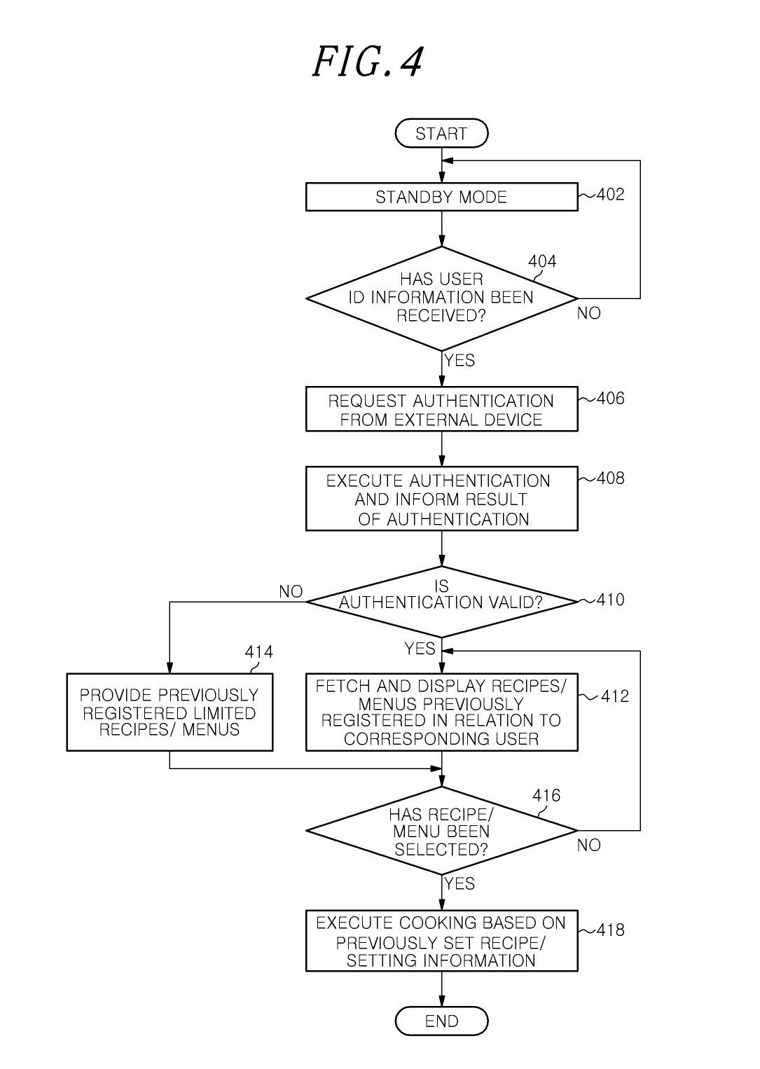

FIG. 4 is a flowchart illustrating major processes of providing user-selective recipe control service based on user authentication in accordance with other exemplary embodiments of the present invention.

Referring to FIG. 4, while the cooking apparatus is in a standby mode at step 402, the ID information acquisition unit 302 determines whether information for the ID of a user using the cooking apparatus is input, acquired, received or recognized at step 404. If the user ID information is received or input, the ID information acquisition unit 302 transfers the user ID information to the remote authentication unit 304.

The remote authentication unit 304 requests authentication of the user ID information received from the ID information acquisition unit 302 from an external device (e.g., the home network controller) by sending the user ID information, together with an authentication request or message, to the external device over a network at step 406.

In response thereto, the external device attempts to authenticate the user ID information requested by the cooking apparatus by searching an internal database DB (i.e., a DB that stores user ID information) for matching user ID information, and sending a result of the authentication attempt (i.e., authentication or no authentication) to the remote authentication unit 304 of the cooking apparatus. Alternatively, the external device informs the remote authentication unit 304 of the authentication result (i.e., authentication or no authentication) at step 408.

In response thereto, the remote authentication unit 304 authenticates or does not authenticate the user ID information depending on the authentication result received from the external device at step 410.

If, as a result of the authentication at step 410, the user ID information is valid or authenticated (e.g., the user ID information is previously registered with the external device), the remote authentication unit 304 informs the recipe and/or menu display unit 306 of the valid authentication. If, as a result of the authentication at step 410, the user ID information is not authenticated or valid (e.g., the user ID information is not previously registered with the external device), the remote authentication unit 304 informs the recipe and/or menu display unit 306 of the non-authentication.

When the validation and/or authentication indicating that the user ID information is valid, the information is received from the remote authentication unit 304 through the authentication process, the recipe and/or menu display unit 306 searches the user-based recipe information DB 308 for recipes and/or menus previously stored or registered by the user and for recipe and/or setting information for the respective recipe menus, and outputs or displays the retrieved recipes and/or menus and/or the recipe and/or setting information to and in the display panel at step 412.

Accordingly, the user may designate or select one of the recipes and/or menus displayed on a screen of the display panel or interface, and manipulate (e.g., change one or more settings, delete the recipe, etc.) the recipe for the selected recipe and/or menu at step 416. When the user selects one of the recipes and/or menus, optionally manipulates the recipe, and instructs the cooking apparatus to start the selected recipe or menu, the recipe execution unit 310 executes the selected recipe or menu based on the recipe and/or setting information that is related to or associated with the selected recipe and/or menu at step 418.

In contrast, when the non-authentication indicating that the user ID information is invalid, the information is received from the remote authentication unit 304 through the authentication process, the recipe and/or menu display unit 306 fetches or retrieves previously set or stored basic recipe and/or menu information from the user-based recipe information DB 308, configures a limited menu selection screen using the fetched or retrieved basic recipe and/or menu information, and provides or outputs the limited menu selection screen to the display panel at step 414.

Accordingly, the user may designate or select one of the basic recipes and/or menus displayed on a screen of the display panel or interface, manipulate the recipe and/or menu, and start the selected recipe and/or menu at step 416. When the user selects one of the basic recipes and/or menus and starts the selected recipe or menu, the recipe execution unit 310 executes the selected basic recipe or menu based on the displayed basic recipe and/or setting information related to or associated with the selected basic recipe or menu at step 418.

In the present embodiments, a user may select from only basic recipes and/or menus provided to unregistered or invalid users, or from a plurality of recipes and/or menus provided by the cooking apparatus. Alternatively, as in the aforementioned embodiment 1, the cooking apparatus may stop or be turned off automatically when user ID information is invalid, unrecognized, or not authorized (e.g., non-authentication). In such a case, the cooking apparatus may provide a visual and/or auditory alarm when it is stopped or turned off.

In accordance with the present invention, if user ID information for executing a recipe is authenticated, previously registered, or valid, only pieces, parts or portions of recipe and/or setting information corresponding to respective recipes and/or menus that have been previously stored by the corresponding user are displayed, and a specific recipe menu is executed based on selection of the recipe and/or setting information for the specific recipe or menu by the corresponding user. Accordingly, a user interface for selecting previously stored recipes and/or menus and executing cooking operations may be simplified, and user convenience may be enhanced.

Furthermore, in accordance with the present invention, if a user is not previously registered or a valid user, only previously set or stored recipes and/or menus are provided by the cooking apparatus, recipe and/or setting conditions in the recipes and/or menus are limited, and/or the operations of the cooking apparatus are limited. Accordingly, accidents, especially involving a child using the cooking apparatus unsupervised, can be effectively prevented.

While the invention has been shown and described with respect to certain embodiments, the present invention is not limited thereto. It will be understood by those skilled in the art that various changes and modifications may be made without departing from the scope of the invention as defined in the following claims.

Accordingly, the scope of the present invention should be interpreted based on the following appended claims, and all technical spirits within an equivalent range thereof should be construed as being included in the scope of the present invention.

What is claimed is:

1. A method for controlling a recipe based on user authentication, comprising:
authenticating user identification (ID) information by searching an ID information database and recognizing the user ID information;
fetching, retrieving or reading recipe and/or setting information (or one or more pieces, portions or parts thereof) for respective recipes and/or menus previously registered and/or stored in relation to or association with the authenticated and/or recognized user ID information from a user-based recipe information database; and
executing a selected recipe and/or menu when a previously registered recipe and/or menu is selected.

2. The method of claim 1, further comprising matching recipe and/or setting information for a specific recipe and/or menu with the user ID information by providing the recipe and/or setting information for the specific recipe and/or menu and storing the matched recipe and/or setting information and specific recipe and/or menu in the user-based recipe information DB.

3. The method of claim 2, wherein the user ID information comprises fingerprint recognition information, iris recognition information, and/or face recognition information.

4. The method of claim 1, wherein the recipe and/or setting information comprises at least one of a heating time, a heating temperature, and a heating method.

5. The method of claim 4, wherein the recipe setting information comprises a recipe start and/or schedule time.

6. The method of claim 1, further comprising:
providing previously set basic recipes and/or menus when the user ID information is not valid; and
executing the selected basic recipe and/or menu.

7. The method of claim 1, further comprising stopping, shutting down or turning off the cooking apparatus when the user ID information is not to be valid.

8. The method of claim 7, wherein stopping, shutting down, or turning off the cooking apparatus further comprises generating a visual and/or auditory alarm.

9. An apparatus for controlling a recipe based on user authentication, comprising:
a user identification (ID) database (DB) for storing user ID information;
a recipe information database configured to store recipe and/or setting information for respective recipes and/or menus that match one or more user IDs in the user ID DB;
a user ID information acquisition unit configured to acquire and/or receive user ID information;
a user authentication unit configured to authenticate the user ID information and search the ID information DB when the user ID information is received or acquired;
a recipe and/or menu display unit configured to fetch, retrieve and/or read recipe and/or setting information for respective recipes and/or menus associated with or corresponding to the authenticated user ID information from the user-based recipe information database when the user ID information is valid, and display the recipe and/or setting information in a display panel of the cooking apparatus; and
a recipe execution unit configured to execute a selected recipe and/or menu in the display panel.

10. The apparatus of claim 9, wherein the ID information acquisition unit comprises a fingerprint recognizer, an iris recognizer, and/or a face recognizer.

11. The apparatus of claim 9, wherein:
the recipe menu display unit displays a limited menu selection screen including previously set basic recipe menus in the display panel when the user ID information is not authorized, and
the recipe execution unit executes a selected basic recipe and/or menu from one of the previously set basic recipes and/or menus.

12. A method for controlling a recipe based on user authentication, comprising:
requesting an external device to authenticate user ID information by sending the user ID information to the external device;
fetching, retrieving or reading recipe and/or setting information for respective recipes and/or menus, registered and/or stored in a recipe information database associated with or corresponding to the user ID information when the external device authenticates the user ID information; and
executing a selected recipe and/or menu based on corresponding recipe and/or setting information when a one of the registered recipes and/or menus is selected.

13. The method of claim 12, further comprising:
providing an interface that enables selection of previously set basic recipes and/or menus for the cooking apparatus when the external device does not authenticate or validate the user ID information; and
executing a selected basic recipe and/or menu.

14. An apparatus for controlling a recipe based on user authentication, comprising:
a user-based recipe information database configured to store recipe and/or setting information for respective recipes and/or menus that match user identification (ID) information;
an ID information acquisition unit configured to acquire and/or receive ID information of a user using the apparatus;
a remote authentication unit configured to request an external device to authenticate the user ID information and send the user ID information to the external device;
a recipe and/or menu display unit configured to fetch, retrieve or read recipe and/or setting information for respective recipes and/or menus registered or stored in a recipe information database associated with or corresponding to the user ID information when the external device authenticates or validates the user ID information, and display the recipe and/or setting information in a display panel of the apparatus; and
a recipe execution unit configured to execute a selected recipe and/or menu based on corresponding recipe and/or setting information.

15. The apparatus of claim 14, wherein:
the recipe and/or menu display unit displays a limited menu selection screen including previously set basic recipes and/or menus for the apparatus in the display panel when the external device does not authenticate or validate the user ID information, and
the recipe execution unit executes a selected basic recipe and/or menu based on the previously set basic recipe and/or setting information.

16. The apparatus of claim 3, wherein the fingerprint recognizer comprises a fingerprint scanner, and the fingerprint scanner is on a door handle of the cooking apparatus.

17. The apparatus of claim 3, wherein the iris recognizer comprises a camera, and the camera is on an upper end or a lower end of a front panel or section of the apparatus.

18. The apparatus of claim 1, wherein the user ID information is registered and managed using the ID information database, either locally in the apparatus or remotely with an external device.

19. The apparatus of claim 19, wherein the external device comprises a home network controller.
